(19) United States
(12) Patent Application Publication
(10) Pub. No.: US 2019/0157848 A1
(43) Pub. Date: May 23, 2019

(54) EXTENSION CORD RETAINER

(71) Applicant: Len Boren, Roosevelt, UT (US)

(72) Inventor: Len Boren, Roosevelt, UT (US)

(21) Appl. No.: 15/816,215

(22) Filed: Nov. 17, 2017

(51) Int. Cl. H02B 1/28

(52) U.S. Cl. CPC H02B 1/28

(57) ABSTRACT

An extension cord retainer for keeping a pair of extension cords coupled together includes a housing that receives a male mating member of a first extension cord and a female mating member of a second extension cord wherein the male mating member and the female mating member are coupled together and positioned within the housing.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to extension cord protecting devices and more particularly pertains to a new extension cord protecting device for keeping a pair of extension cords coupled together.

### BRIEF SUMMARY OF THE INVENTION

An embodiment of the disclosure meets the needs presented above by generally comprising a housing that is configured to receive a male mating member of a first extension cord and a female mating member of a second extension cord wherein the male mating member and the female mating member are coupled together and positioned within the housing.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of an extension cord retainer according to an embodiment of the disclosure.

FIG. 2 is a back view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a side view of an embodiment of the disclosure.

FIG. 7 is a bottom view of an embodiment of the disclosure.

FIG. 8 is a cross-sectional view of an embodiment of the disclosure taken along line 8-8 of FIG. 3.

### DETAILED DESCRIPTION OF THE INVENTION

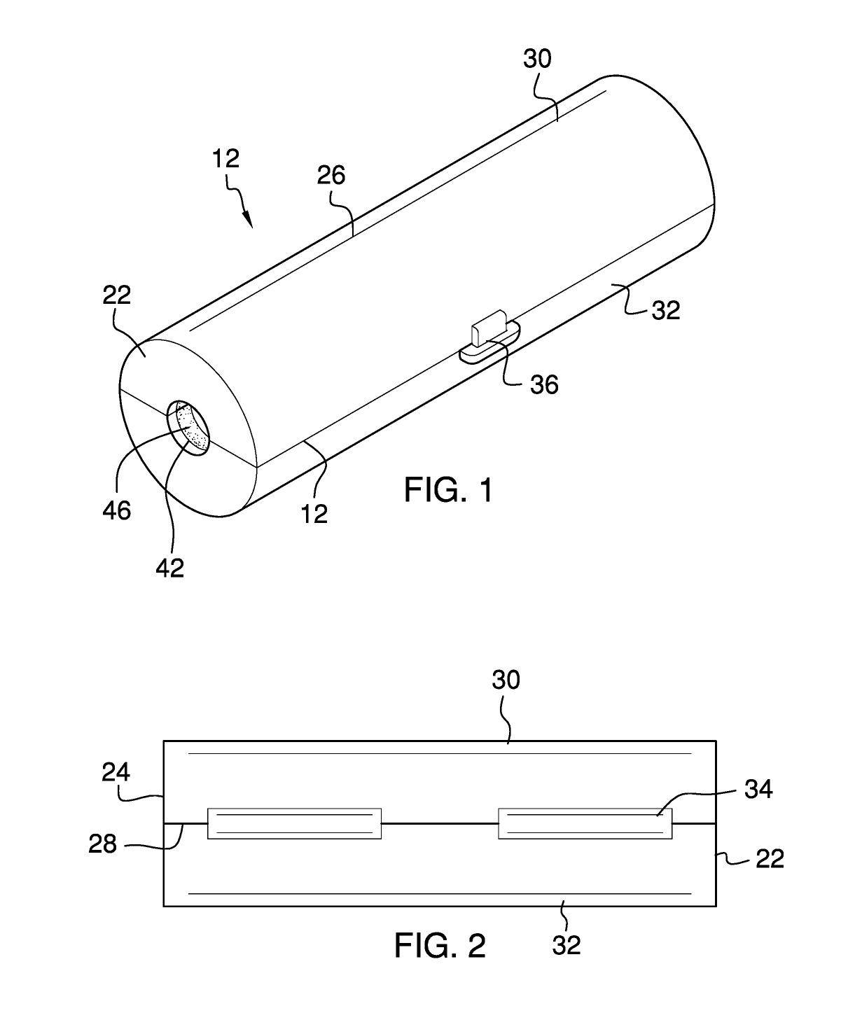

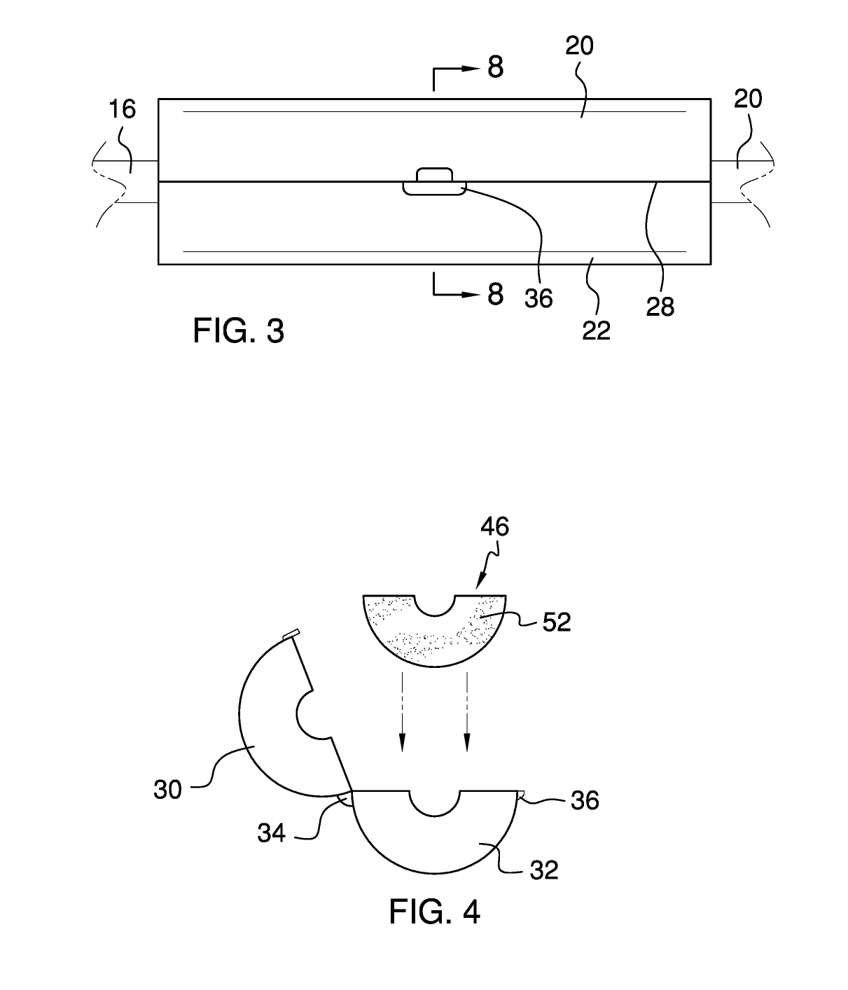

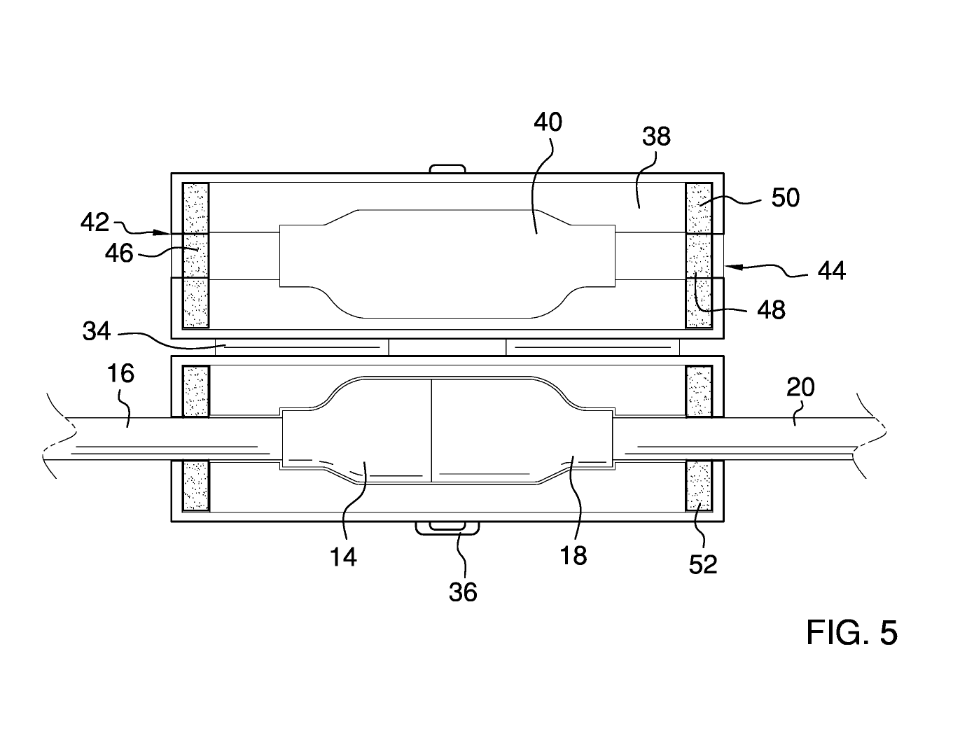

With reference now to the drawings, and in particular to FIGS. 1 through 8 thereof, a new extension cord protecting device embodying the principles and concepts of an embodiment of the disclosure and generally designated by the reference numeral 10 will be described.

As best illustrated in FIGS. 1 through 8, the extension cord retainer 10 generally comprises a housing 12 that receives a male mating member 14 of a first extension cord 16 and a female mating member 18 of a second extension cord 20. The male mating member 13 and the female mating member 18 are coupled together and positioned within the housing 12.

The housing 12 includes a first lateral side 22, a second lateral side 24 and a perimeter wall 26 that is attached to and extends between the first lateral side 22 and the second lateral side 24. The housing 12 has a break 28 therein that is positioned parallel to a longitudinal axis and extends through the first and second lateral sides 22, 24. The break 28 defines a top portion 30 and a bottom portion 32 and an access opening into the housing 12. The top portion 30 and the bottom portion 32 are pivotally coupled together along the perimeter wall 26. The top and bottom portion 30, 32 may be pivotally coupled together by a hinge 34, but may be any other type of mechanical bearing that allows the top portion 30 and bottom portion 32 to pivot relative to each other.

A closure 36 is attached to the perimeter wall 26. The closure 36 is mounted on the perimeter wall 26 and releasably retains the housing 12 in a closed position. The closure 36 may comprise a snap, a zipper, or any other type of fastener suitable to retain the housing 12 in a closed position. An inner surface 38 of the perimeter wall defines a receiving space 40. The receiving space 40 receives the male mating member 14 and the female mating member 18. The housing 12 is closed to retain the male and female mating members 14, 18 within the receiving space 40.

Each of first and second lateral sides 22, 24 has an aperture 42, 44 that extends therethrough. Each of the apertures 42, 44 receives an associated one of the first and second extension cords 16, 18 when the male mating member 14 and the female mating member 20 are coupled and positioned in the receiving space 40.

A pair of gaskets 46, 48 is positioned within the housing. Each of the gaskets 46, 48 abuts one of the first and second lateral sides 22, 24. The gaskets 46, 48 are configured to frictionally engage the first and second extension cords 16, 20 to inhibit liquid from entering the housing 12 through the apertures 43, 44. The break 28 extends through the gaskets 46, 48 such that each of the gaskets 46, 48 comprises a top half 50 and a bottom half 52. Each of the gaskets 46, 48 comprises a resiliently compressible material.

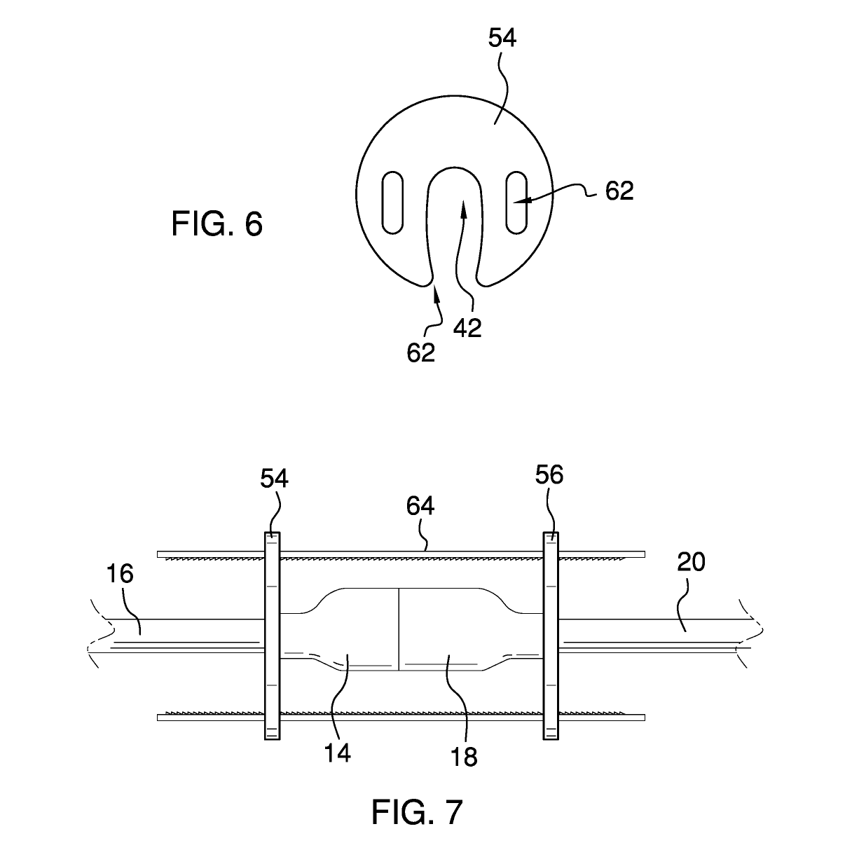

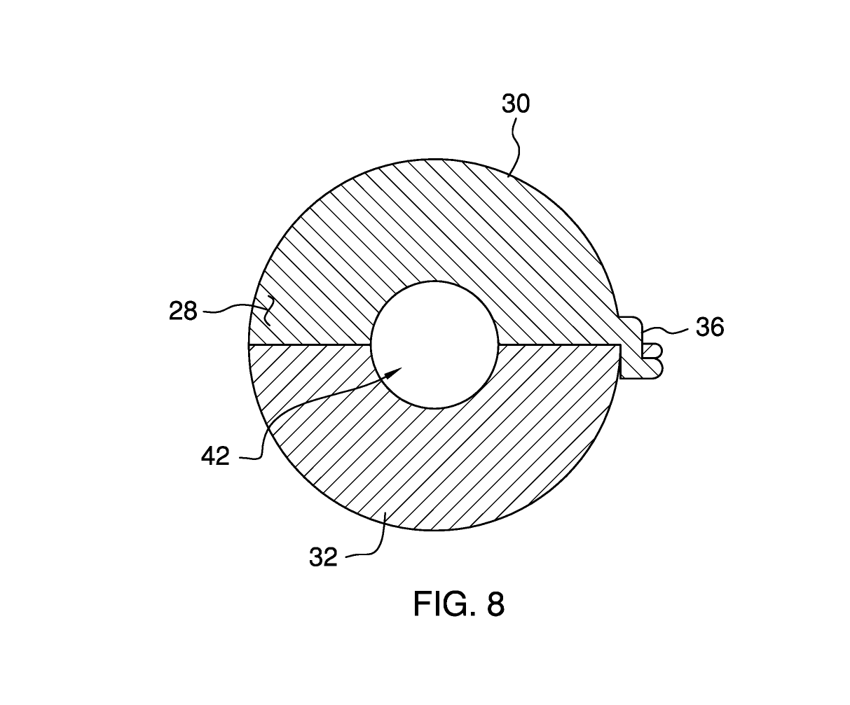

Alternatively, as shown in FIGS. 6 and 7, the assembly 10 may comprise a plurality of securing members, including a first securing member 54 and a second securing member 56. Each of the securing members 54, 56 has an aperture 42, 44 that extends through a middle portion thereof and a slot 58 that extends from a peripheral wall 60 of a corresponding one of the securing members 54, 56 to the aperture 42, 44. The female mating member 18 and the male mating member 14 are coupled and positioned between the first securing member 54 and the second securing member 56. The first and second extension cords 16, 20 are slidably movable through a corresponding one of the slots 58 and into the aperture 42, 44. Each of the securing members 54, 56 has a plurality of slits 62 that extend therethrough and define receiving spaces 40. A zip tie 64, or cable tie, extends through each of the slits 62 thereby coupling one of the securing members 54 to another one of the securing members 56.

In use, the female mating member 18 and the male mating member 14 are coupled. The housing 12 is opened and the coupled mating members 14, 18 are positioned within. The housing 12 is shut and the closure 36 retains the housing in a closed position with the female mating member 18 and male mating members 14 within. The receiving space 40 keeps the male mating member 14 and the female mating member 18 from decoupling.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An extension cord protecting assembly configured to protect and keep a pair extension cords coupled together, said assembly comprising:
a housing being configured to receive a male mating member of a first extension cord and a female mating member of a second extension cord wherein the male mating member and the female mating member are coupled together and positioned within said housing, said housing including:
a first lateral side, a second lateral side and a perimeter wall being attached to and extending between said first lateral side and said second lateral side, said housing having a break therein being positioned parallel to a longitudinal axis extending through said first and second lateral sides, said break defining a top portion and a bottom portion, said break defining an access opening into said housing;
a closure being attached to said perimeter wall, said closure being mounted on said perimeter wall and releasably retaining said housing in a closed position;
an inner surface of said perimeter wall defining a receiving space, said receiving space being configured to receive the male mating member and the female mating member, said housing being configured to be closed to retain the male and female mating members within said receiving space;
each of first and second lateral sides having an aperture extending therethrough, each of said apertures being configured to receive an associated one of the first and second extension cords when the male mating member and the female mating member are coupled and positioned in said receiving space; and
a pair of gaskets positioned within said housing, each of said gaskets having an outwardly facing surface and an inwardly facing surface relative to said housing, said outwardly facing surface and said inwardly facing surface each being planar and parallel, said outwardly facing surface abutting and lining fully an interior surface of a respective one of said first and second lateral sides such that said outwardly facing surface terminates flush with an inner edge of said aperture in said respective one of said first and second lateral sides, said gaskets being configured to frictionally engage the first and second extension cords to inhibit liquid from entering said housing through said apertures, said break extending through said gaskets such that each of said gaskets comprises a top half and a bottom half.

2. The extension cord protecting assembly according to claim 1, wherein said top portion and said bottom portion are pivotally coupled together along said perimeter wall.

3. (canceled)

4. The extension cord protecting assembly according to claim 1, wherein each of said gaskets comprises a resiliently compressible material.

5. An extension cord protecting assembly configured to protect and keep a pair extension cords coupled together, said assembly comprising:
a housing being configured to receive a male mating member of a first extension cord and a female mating member of a second extension cord wherein the male mating member and the female mating member are coupled together and positioned within said housing, said housing including:
a first lateral side, a second lateral side and a perimeter wall being attached to and extending between said first lateral side and said second lateral side, said housing having a break therein being positioned parallel to a longitudinal axis extending through said first and second lateral sides, said break defining a top portion and a bottom portion, said break defining an access opening into said housing, said top portion and said bottom portion being pivotally coupled together along said perimeter wall;
a closure being attached to said perimeter wall, said closure being mounted on said perimeter wall and releasably retaining said housing in a closed position;
an inner surface of said perimeter wall defining a receiving space, said receiving space being configured to receive the male mating member and the female mating member, said housing being configured to be closed to retain the male and female mating members within said receiving space;
each of first and second lateral sides having an aperture extending therethrough, each of said apertures being configured to receive an associated one of the first and second extension cords when the male mating member and the female mating member are coupled and positioned in said receiving space; and
a pair of gaskets positioned within said housing, each of said gaskets having an outwardly facing surface and an inwardly facing surface relative to said housing, said outwardly facing surface and said inwardly facing surface each being planar and parallel, said outwardly facing surface abutting and lining fully an interior surface of a respective one of said first and second lateral sides such that said outwardly facing surface terminates flush with an inner edge of said aperture in said respective one of said first and second lateral sides, said gaskets being configured to frictionally engage the first and second extension cords to inhibit liquid from entering said housing through said apertures, said break extending through said gaskets such that each of said gaskets comprises a top half and a bottom half, each of said gaskets comprising a resiliently compressible material.
